(19) United States
(12) Patent Application Publication
(10) Pub. No.: US 2025/0005681 A1
(43) Pub. Date: Jan. 2, 2025

(54) METHOD FOR CREATING A LIQUID MARKET FOR TAX CREDITS

(71) Applicant: Xofia, Inc., Houston, TX (US)

(72) Inventor: CARLOS ALBERTO SANMIGUEL BEJARANO, Houston, TX (US)

(21) Appl. No.: 18/342,462

(22) Filed: Jun. 27, 2023

(51) Int. Cl. G06Q 40/10; G06Q 40/06

(52) U.S. Cl. CPC G06Q 40/10; G06Q 40/06

(57) ABSTRACT

A method for creating a liquid market for tax credits by acquisition of the tax credits from third parties, allowing for fractionalization of the tax credits to create derivative financial instruments. The derivative financial instruments can then be transferred individually or in a bundle by sale, donation, or the like.

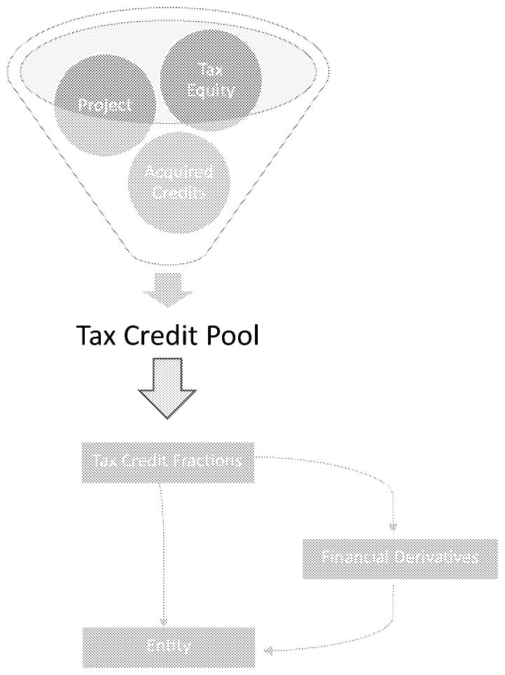

### FIELD

The present disclosure generally relates to a method for creating a liquid market for tax credits.

### BACKGROUND

Tax policy often plays an imperative function in incentivizing entities to perform vital tasks necessary for the greater good. Tax credits allow businesses to deduct a portion of their investment in various projects, thereby reducing the cost associated with the projects, increasing profit margins, and overall providing several economic motivations to undertake the projects or type of projects.

One such exemplary task is to make improvements in the environmental, social, and governance (“ESG”) space. For example, by providing tax credits, corporations can be subsidized and incentivized to undertake green initiatives to help combat climate change, or otherwise improve the environment.

Businesses can manage cash flow and tax liability by transferring the tax credit to another entity by sale, donation, or the like. By selling tax credits, businesses can generate a revenue stream which pulls realization of such tax credit revenue forward. In addition, companies in need of “green” credits to offset their business activities can purchase such credits from other “green” businesses.

The present disclosure provides a method for creating a liquid market for tax credits by allowing for their fractionalization, or the division of the tax credits into smaller portions, followed by a transfer tracked via a block chain record.

### SUMMARY OF THE INVENTION

The present disclosure provides a method for creating a liquid market for tax credits by allowing for their fractionalization and transfer. A tax credit is acquired either from a third party or via partnering with a third party. The tax credit is then fractionalized and each fraction is assigned a value assigned. The tax credit fractions are then transferred to an entity desiring to acquire them.

As tax credits are often created in large “block” amounts, smaller businesses may not have the funds or wherewithal to participate in the purchase and use of such credits. Therefore, the fractionalization of the tax credit allows for greater liquidity, superior alienability of the tax credit, and the creation of a heretofore non-existent market.

### BRIEF DESCRIPTION OF THE DRAWINGS

The detailed description will be better understood in conjunction with the accompanying figure.

The figure shows a schematic of one embodiment of the disclosed method.

The embodiments of the present disclosure are detailed below with reference to the listed Figure.

### DETAILED DESCRIPTION OF THE EMBODIMENTS

Before explaining the present disclosure in detail, it is to be understood that the present disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely an exemplary order of operations unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural, or other details supplementary to those set forth herein.

The embodiments of the present disclosure generally relate to a method for creating a liquid market for tax credits by allowing for their fractionalization and transfer.

While exemplary embodiments may be described in relation to carbon offset credits, this is not intended to be limiting in any manner and the method can be practiced with any applicable tax credit allowed by tax code to be transferred. The term “tax credit”, as used herein, refers to traditional credits as known to persons having ordinary skill in the art, but also encompasses any other transferable tax benefits, such as deductions, offsets, forgiveness, and the like.

A method for creating a liquid market for tax credits comprising: acquiring a tax credit, fractionalizing the tax credit to create a tax credit fraction, and transferring the tax credit fraction.

The method can include the step of acquiring a tax credit. In embodiments, the tax credit can be purchased if allowed to be freely transferred. In other embodiments, the tax credit can be acquired via investment in, or partnership with, an entity performing qualified tasks which result in a tax credit being issued. A qualified task can be defined by tax code, or determined by government regulations. An exemplary qualified task may be a “qualified project” identified by tax code to receive carbon offset credits, and the like.

By investing or partnering with entities having access to a tax credit, the tax credit can be acquired without creating a transfer of the credit as defined by tax codes. In many instances, a tax credit can only be transferred one time from one entity to another.

Therefore, the acquisition of a tax credit without it being defined as a transfer between entities is highly desirable and novel to the current methodology.

In embodiments, the tax credit is not yet earned, so quantitative methods are used to assess the value of tax benefits, as well as the associated risk and pricing of assets based on the relevance and certainty of the projects generating tax benefits. Statistical and computational techniques can be used to model future performance and pricing trends. Based upon the above analysis, a valuation of the tax credit can be determined with a discount for associated risk.

Multiple tax credits can be acquired and valued, either individually or in a pool of tax credits. The tax credits can be pooled in an entity to aggregate the total value or can be kept in separate entities as desired by persons having ordinary skill in the art.

An algorithmic valuation of either a pool of tax credits or a single tax credit can be utilized to then generate a derivative financial instrument representing all or a fractional portion of the value of either a pool of tax credits or a single tax credit. The derivative instrument can then be sold to end users wishing to make use of a tax credit. In this manner the tax credits can (either individually or in aggregate) be fractionalized into smaller portions of the tax credit. In embodiments, the fractional portions need not be of identical value.

Through the creation of the derivative financial instrument(s), a previously illiquid asset, the tax credit, is made transferable to multiple entities.

In embodiments, the derivative financial instrument can be inscribed into a smart contract on a blockchain, thus creating a permanent and static record of the transfer and usage of tax credits. This ensures proper reporting for tax purposes and also prevents any portion of the tax credit from inadvertently being claimed by more than one entity.

In embodiments, each derivative financial instrument can be tracked by creating an associated non-fungible token (NFT), thereby further easing the process of transfer and tracking.

The value of the tax credit can be fixed at the time of transfer of the tax credit, or of the NFT. This allows for certainty in the value of the transfer and prevents both transferor and transferee from having to speculate as the asset may appreciate or depreciate.

Some or all of the tax credits can be secured by the issuance of debt, bonds, or other asset backed securities. This security can be in the form of financial instruments collateralized by the pool of tax credits. This allows for liquidity of an amount based upon the value of the tax credits without relying on the maturation of the tax credits themselves.

The plurality of tax credits can be digitized either in aggregate or in fractions of the aggregate and recorded in a block chain. In embodiments, a non-fungible token (“NFT”) can be created to simplify transfer of the plurality of tax credits or the aggregate tax credit fractions. Also, a financial derivative instrument can be created from the aggregate tax credit fractions, and an NFT can be created to simplify transfer of the financial derivative.

Turning now to the Figure, the disclosed method is shown schematically.

A tax credit pool is created by combining tax credits from various sources. Exemplary sources may be via tax credit from performance of qualified tasks or projects, purchase or other acquisition of tax credits, tax equity from investment in qualified tasks or projects, etc.

The Tax credit pool can then be fractionalized. The tax credit fractions can then be either transferred to another entity via sale, donation, or the like. Alternatively, financial derivatives can be created from the tax credit fractions and the derivative instruments can then be transferred to another entity via sale, donation, or the like.

While the present disclosure emphasizes the presented embodiments and Figures, it should be understood that within the scope of the appended claims, the disclosure might be embodied other than as specifically enabled herein.

What is claimed is:

1. A method for creating a liquid market for tax credits comprising:
a. acquiring a tax credit;
b. fractionalizing the tax credit to create a tax credit fraction; and
c. transferring the tax credit fraction.

2. The method of claim 1, wherein the tax credit is acquired via investment in a qualified project.

3. The method of claim 1, wherein the tax credit is acquired without causing a transfer of the tax credit.

4. The method of claim 1, wherein fractionalizing the tax credit comprises the step of creating a derivative financial instrument, wherein the derivative financial instrument is transferable.

5. The method of claim 1, wherein the tax credit fraction is tracked by creating a non-fungible token (NFT).

6. The method of claim 1, wherein the tax credit fraction can be of variable value.

7. The method of claim 1, wherein the tax credit fraction value is fixed at a time of transfer.

8. A method for creating a liquid market for tax credits comprising:
a. acquiring a plurality of tax credits;
b aggregating the plurality of tax credits;
c. applying an algorithm to determine a value of the aggregated plurality of tax credits;
d. fractionalizing the value of the aggregated plurality of tax credits to create an aggregate tax credit fraction;
e. transferring the aggregate tax credit fraction.

9. The method of claim 8, wherein each tax credit of the plurality of tax credits is acquired without causing a transfer of each tax credit of the plurality of tax credits.

10. The method of claim 8, further comprising the step of securing the plurality of tax credits.

11. The method of claim 8, further comprising the step of digitizing the plurality of tax credits.

12. The method of claim 8, further comprising the step of creating a non-fungible token (NFT) for the aggregate tax credit fraction.
